(19) United States
(12) Patent Application Publication
(10) Pub. No.: US 2026/0241988 A1
(43) Pub. Date: Aug. 20, 2026

(54) STEERING SYSTEM FOR A VEHICLE, IN PARTICULAR UTILITY VEHICLE

(71) Applicant: KNORR-BREMSE SYSTEME FÜR NUTZ-FAHRZEUGE GMBH, München (DE)

(72) Inventor: Markus Lichtenstein, Köln (DE)

(21) Appl. No.: 19/472,021

(22) PCT Filed: Mar. 21, 2024
(86) PCT No.: PCT/EP2024/057543

§ 371 Date: Oct. 2, 2025

(30) Foreign Application Priority Data
Apr. 14, 2023 (DE) 10 2023 109 483.1

(51) Int. Cl. B62D 5/18; B62D 5/06; B62D 5/08

(52) U.S. Cl. CPC B62D 5/18; B62D 5/062; B62D 5/08

(57) ABSTRACT

An electrohydraulic steering system for a vehicle, in particular a utility vehicle, includes at least one steering gear, in particular a spindle steering gear, with at least one steering gear housing; at least one first hydraulic, in particular electrohydraulic, assembly which can be fastened to the steering gear housing; and at least one second hydraulic, in particular electrohydraulic, assembly is/are integrated at least partially into a first housing block, and wherein one or more components of the second hydraulic assembly is/are integrated at least partially into a second housing block, or wherein one or more components of the first hydraulic assembly and the second hydraulic assembly is/are integrated at least partially into a common housing block. A vehicle, in particular a utility vehicle, includes the above-described steering system.

The present invention relates to an electrohydraulic steering system for a vehicle, in particular a utility vehicle. The present invention furthermore relates to a vehicle, in particular a utility vehicle, comprising this electrohydraulic steering system.

In conventional steering systems for utility vehicles, hydraulic elements, such as filters, valves and/or control elements such as actuators, give rise to large installation space requirements, which have a negative effect on the power density and performance and functional density of these steering systems.

In the prior art, steering systems for vehicles and, more specifically, for utility vehicles are already known.

Thus, DE 102016112332 A1 shows a method for monitoring a controller block for controlling an actuating drive, in particular an actuating drive of a steering system.

It is the object of the present invention to further develop an electrohydraulic steering system of the type stated at the outset in an advantageous manner, in particular to the effect that this system has a higher power density and can be constructed in a simpler way and with fewer components and/or lines, with the result that potential sources of faults can be eliminated.

According to the invention, this object is achieved by an electrohydraulic steering system having the features of claim 1. According to this, it is envisaged that an electrohydraulic steering system for a vehicle, in particular a utility vehicle, is provided, which system comprises the following:
at least one steering gear, in particular a spindle steering gear, with at least one steering gear housing;
at least one first hydraulic, in particular electrohydraulic, assembly, which can be secured on the steering gear housing; and
at least one second hydraulic, in particular electrohydraulic, assembly, which can be secured on the steering gear housing; wherein
   one or more components of the first hydraulic assembly is/are integrated at least partially into a first housing block, and wherein
   one or more components of the second hydraulic assembly is/are integrated at least partially into a second housing block, or wherein
   one or more components of the first hydraulic assembly and of the second hydraulic assembly is/are integrated at least partially into a common housing block.

The invention is based on the underlying concept that one or more components of the first and/or second hydraulic assembly can be integrated at least partially into a first and second or common housing block. This allows a very high power density with internal line routing within the housing block, thereby making it possible to eliminate elasticities (and thus inertias) and additional sources of faults in the steering system. It is also possible to provide for all the components of the first and second hydraulic assemblies to be integrated respectively into the first and second or the common housing block. Such integration can be understood as meaning that one or more components do not have to be fully integrated or embedded structurally into the housing block (e.g. in the case of a switching valve, the valve tappet and certain connections can be integrated, while the control or actuating zone and possibly external connections can be arranged outside the housing block or flanged to the latter.) A valve block can be configured such that the holes, lines, wall structures etc. required for the one or more components are introduced into a solid block material, thus forming the housing block. Here, the common housing block can contain all the components of the first and second hydraulic assemblies. As an alternative, however, it may also be conceivable for the common housing block to contain only some of the components of the first and second hydraulic assemblies. The common housing block can be produced as a solid block material produced as a single piece (e.g. from an aluminum alloy). The first and second hydraulic assemblies should be understood as separate assemblies, differing at least in one function and/or in one structural component.

Alternatively, the common housing block can comprise the first housing block and the second housing block. This configuration allows a two-part configuration of the common housing block and thus more variable configuration of the first and second hydraulic assemblies. For this purpose, the first and second housing block can be secured on one another (e.g. by screw fastening or welding or similar suitable methods).

In addition, provision can be made for the first hydraulic assembly to comprise at least one hydraulic pump and at least one electric motor for driving the hydraulic pump, by means of which the steering gear can be supplied and/or controlled with hydraulic fluid. By the at least partial integration of the hydraulic pump into the first housing block, it is possible to shorten the flow path from the pump to the steering gear for the supply and control of the latter, thus enabling the steering gear to be controlled and supplied with hydraulic fluid (e.g. designed as hydraulic oil suitable for steering gears) more quickly, more precisely and with lower line losses.

Moreover, the first hydraulic assembly can comprise at least one first line, which is connected to at least one first working space of the steering gear housing and by means of which the first working space can be supplied and/or controlled with hydraulic fluid. Moreover, the first hydraulic assembly can comprise at least one second line, which is connected to at least one second working space of the steering gear housing and by means of which the second working space can be supplied and/or controlled with hydraulic fluid. By virtue of the provision of the first and second lines within the first and/or second or common housing block, the line length thereof is very short, thereby enabling the steering gear to be controlled and supplied with hydraulic oil more quickly, more precisely and with lower line losses. Moreover, the first and second lines can be introduced directly into the respective block (e.g. as a hole, groove or other recess), thus making it possible to achieve a very simple configuration of these lines.

It is furthermore conceivable that the hydraulic pump is designed as a bidirectional hydraulic pump with a first and second delivery direction and is connected to the first line and to the second line, wherein the hydraulic pump is configured to pressurize the first line in accordance with the first delivery direction and to pressurize the second line in accordance with the second delivery direction. Since the steering gear piston for the application of the steering power assistance must in any case be pressurized in different directions on both sides on its respective end faces and in the two working spaces formed there, the bidirectional pump is a particularly advantageous choice for this use. This is because, by virtue of its operation, reversal of its direction of rotation automatically changes its delivery direction, and therefore the pressurization of the two working spaces of the steering gear can be implemented very easily via the first and second lines. Thus, a very effective pump configuration for the correspondingly adapted application in a steering gear is obtained with this configuration.

It is furthermore conceivable that the second hydraulic assembly is designed as a backup assembly and, in at least one fault condition and/or in at least one inactivity condition of the steering system, is connected to the steering gear. If a fault condition arises in the first hydraulic assembly, the hydraulic fluid or hydraulic oil can no longer flow in and out of the first or second working space from there, and therefore it would no longer be possible to actuate the steering gear. For this reason, the second hydraulic assembly can be provided, which short circuits a connection between the first and second working spaces (e.g. in a fault condition), ensuring that the steering gear can still be controlled and the utility vehicle thus remains safely steerable. As an alternative or in addition, the backup assembly can also be controlled in an inactivity condition in such a way (e.g. by an open-loop and/or closed-loop control device of the steering system) that a connection between the two working spaces is enabled, giving the possibility of efficient implementation of a further functionality for the steering system in the case of an inactivity condition in the second hydraulic assembly.

Moreover, provision can be made for the second hydraulic assembly to form at least one hydraulic filter element and at least one backup switching valve. The backup switching valve performs essentially the following function: fundamentally, the backup switching valve can be switched from a blocking position to a through flow position and vice versa, with the result that the two working spaces of the steering gear are connected via the second assembly and thus the vehicle is still steerable. This is advantageous particularly in a fault condition because, owing to the hydraulic short circuit (made possible by the second assembly), the working spaces of the steering gear are connected as before and thus the steerability of the steering gear continues to be ensured. In the blocking position of the backup switching valve, the second assembly is out of operation, and the control of the steering gear and the supply thereof with hydraulic fluid is accomplished via the first assembly. The integration of the hydraulic filter element into the second assembly has the advantage that, particularly in the inactivity condition, the second assembly can be occupied with an additional functionality, namely the filtering of the hydraulic oil.

Furthermore, provision can be made for the hydraulic filter element and the backup switching valve to form a series circuit. This circuit provides a very efficient possibility for the hydraulic fluid to flow through the hydraulic filter element in a controlled manner and with a flow path that is as short as possible. As a result, the flow resistance falls, and the efficiency of the steering system in the filtering of the hydraulic fluid or oil can be increased.

Moreover, provision can be made for the second hydraulic assembly to comprise at least one further first line and at least one further second line. In particular, the further first line can be connected to the first working space of the steering gear housing and the further second line can be connected to the second working space of the steering gear housing. By virtue of the provision of the further first and further second lines within the respective housing block (depending on configuration), the line length thereof is very short, thereby enabling the steering gear to be supplied with hydraulic oil more quickly, more precisely and with lower line losses in the fault condition or inactivity condition. Moreover, the further first and further second lines can be introduced directly into the respective block (e.g. as a hole, groove or other recess), thus making it possible to achieve a very simple configuration of these lines.

It is furthermore conceivable that the backup switching valve is switched to a through flow position in the inactivity condition and/or fault condition, such that the first working space and the second working space are connected at least by the further first and further second line and via the hydraulic filter element and the backup switching valve. The first condition relates to a fault condition in which, for example, the power supply has failed and a return spring then switches the backup switching valve into a through flow position, with the result that the two working spaces of the steering gear are connected and thus the vehicle is still steerable. The second function or the second condition relates to the inactivity condition, in which future steering assistance (and hence no pressurization of the steering gear) of the steering system is not to be expected. In this condition, it is advantageously possible to make use of the further functional occupation of the second assembly (namely the filtering of the hydraulic oil). This is because the hydraulic pump must operate continuously, such that the driver feels a certain sense of resistance to steering and because it is only if the hydraulic pump is already operating that steering power assistance can be generated with sufficient rapidity. Accordingly, the operation of the pump in the inactivity condition can be exploited in such a way that the hydraulic pump pressurizes one of the two working spaces in such a way that the pressurization must be below a pressure threshold which would initiate actual steering assistance (this being possible by virtue of the system inertias and friction). In this case, hydraulic oil flows from the pressurized working space, via the backup assembly, into the unpressurized working space of the steering gear and vice versa (in the case of opposite pressurization). Since the filter element is arranged in the backup assembly, the hydraulic oil can thus be filtered in a very energy-efficient way.

In addition, the backup switching valve can be designed as a 2/2-way solenoid valve and can have at least one switching tappet and at least one solenoid for actuating the switching tappet. Here, a change in the switching position of the switching tappet can trigger an induced voltage in the solenoid. For system safety, this switching position is an important monitoring variable or an important monitoring parameter, which should always be precisely monitored. By way of the induced voltage in the solenoid, the coil current collapses, this being detectable, and it is therefore a very simple matter to monitor the tappet position. Moreover, a 2/2-way solenoid valve is a valve of simple construction with a correspondingly reduced probability of faults or failure, which makes a positive contribution to system safety.

In addition, the second hydraulic assembly can comprise at least one bridge circuit, which has four outer arms and a bridge arm, wherein the four outer arms are connected to one another by four outer nodes. Such a bridge circuit allows unidirectional flow through the hydraulic filter element, even though the flow directions within the further first and further second line change depending on the pressurization in the two working spaces of the steering gear housing (see description above). As a result, the hydraulic filter element can be of simpler construction since it is only ever flowed through in a defined flow direction.

Provision can furthermore be made for the bridge arm to be formed by the series circuit comprising the hydraulic filter element and the backup switching valve. In particular, this configuration of the bridge arm allows unidirectional flow through the hydraulic filter element with the advantages explained in the paragraph above.

Moreover, it is conceivable that the bridge circuit is connected to the further first line and the further second line by means of two outer nodes, and wherein the bridge arm is connected to two further outer nodes. This interconnection results in symmetrical connection or interconnection with the further first and further second line and the bridge arm, with the result that the line lengths in both flow paths or directions are the same and thus an identical control characteristic (e.g. in the fault condition) between the two opposite movements of the control piston of the steering gear is obtained.

Furthermore, according to the invention, a vehicle, in particular a utility vehicle, comprising at least one electrohydraulic steering system as described above is provided.

All the advantages and technical effects that can be achieved with the steering system according to the invention can apply individually or in combination to the vehicle according to the invention as well. In particular, the vehicle can be a utility vehicle.

Further details and advantages of the invention will now be explained in greater detail by means of the exemplary embodiment illustrated in the drawing.

In the drawing:

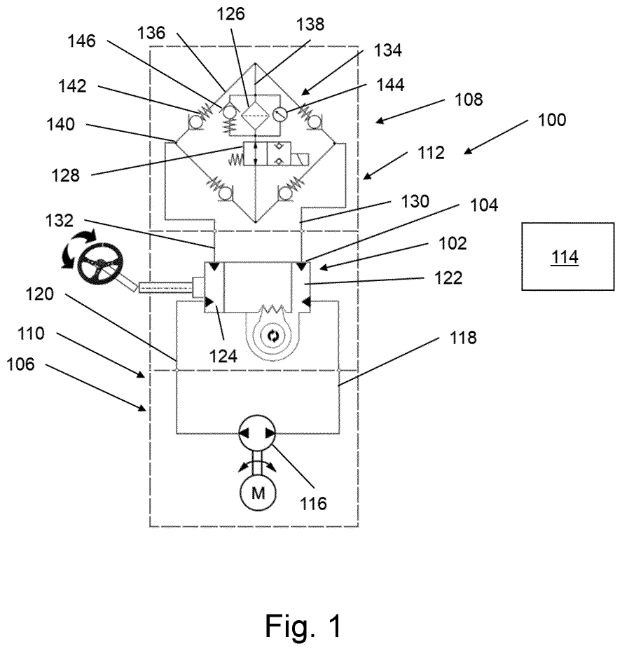

FIG. 1 shows a schematic illustration of a circuit arrangement of one exemplary embodiment of a steering system according to the invention.

FIG. 1 shows a schematic illustration of a circuit arrangement of one exemplary embodiment of a steering system 100 according to the invention.

The electrohydraulic steering system 100 for a utility vehicle comprises a steering gear 102 in the form of a spindle steering gear 102, which in turn has a steering gear housing 104.

The spindle steering gear 102 can be configured as a recirculating ball spindle steering gear, although other types of gear are also conceivable.

The electrohydraulic steering system 100 furthermore comprises a first hydraulic assembly 106, which is secured on the steering gear housing 104.

The first hydraulic assembly 106 is in the form of an electrohydraulic assembly 106.

In addition, the electrohydraulic steering system 100 comprises a second hydraulic assembly 108, which is secured on the steering gear housing 104.

The second hydraulic assembly 108 is also designed as an electrohydraulic assembly 108.

The first and second hydraulic assemblies 106, 108 can be secured on the steering gear housing 104 by means of corresponding flange connections, but these are not shown in the schematic illustration in FIG. 1.

As illustrated in FIG. 1, several components of the first hydraulic assembly 106 are integrated at least partially into a first housing block 110.

In corresponding fashion, several components of the second hydraulic assembly 108 are integrated at least partially into a second housing block 112.

According to FIG. 1, the first and second housing blocks 110, 112 are designed as structurally separate blocks and are secured at different locations on the steering gear housing 104.

For example, the first and second housing blocks 110, 112 can be secured at opposite locations on the steering gear housing 104 (i.e. in a 180° alignment with one another).

It is likewise also conceivable for the first and second housing blocks 110, 112 to be secured on the steering gear housing 104 in a 90° or 270° alignment.

According to an alternative configuration of the housing block of the steering system 100, it is also possible for one or more components of the first hydraulic assembly 106 and of the second hydraulic assembly 108 to be integrated at least partially into a common housing block (not shown in FIG. 1).

The common housing block can comprise the first housing block 110 and the second housing block 112, or can be constructed from these two blocks 110, 112 or, alternatively, can also be configured as a one-piece housing block (from a solid block material).

Moreover, the steering system 100 comprises an electronic open-loop and/or closed-loop control device 114 for open-loop and/or closed-loop control of the first and second hydraulic assemblies 106, 108.

As components, the first hydraulic assembly 106 comprises a hydraulic pump 116 and an electric motor M for driving the hydraulic pump 116.

The hydraulic pump 116 is designed as a double-acting or as a bidirectional hydraulic pump with a first and second delivery direction.

The first hydraulic assembly 106 furthermore comprises a first line 118, which is connected to a first working space 122 of the steering gear housing 104.

Accordingly, the first hydraulic assembly 106 also comprises a second line 120, which is connected to a second working space 124 of the steering gear housing 104.

In FIG. 1, it can be seen that the hydraulic pump 116 is connected to the first line 118 and to the second line 120.

As an alternative to the configuration described above, it may also be conceivable to provide just a single-acting hydraulic pump, which is connected to the first and second line 118, 120 by a corresponding switching valve (not shown in FIG. 1) which, depending on the switching logic, connects this hydraulic pump to the first or the second line 118, 120.

Alternatively, it may also be conceivable that two hydraulic pumps can be provided, wherein a pump is assigned or connected to each of the first and second lines 118, 120.

According to FIG. 1, the first line 118 extends from a first pressure output of the hydraulic pump 116 to a port of the steering gear housing 104 which opens into the first working space 122.

The second line 120 extends from a second pressure output of the hydraulic pump 116 to a port of the steering gear housing 104 which opens into the second working space 124.

A hydraulic filter element can be arranged in each of the first and second lines 118, 120.

According to FIG. 1, a pressure sensor is furthermore arranged in the first line 118.

Moreover, a pressure sensor and a temperature sensor are arranged in the second line 120.

In addition or as an alternative, it is conceivable also for a temperature sensor to be arranged in the first line 118.

The first hydraulic assembly 106 furthermore has a hydraulic tank, which can be fully or partially integrated into the first housing block 110.

Alternatively, it is also conceivable for the hydraulic tank to be flanged to the first housing block 110.

The hydraulic tank is illustrated in a purely schematic way by means of FIG. 1, and therefore it may also be conceivable for the hydraulic pump 116 to be integrated into the tank.

As an alternative or in addition, it is also conceivable for the electric motor, the hydraulic tank and the hydraulic pump 116 to be flanged to one another and connected by corresponding lines (not shown in FIG. 1).

The hydraulic tank is furthermore assigned a pressure sensor and a temperature sensor for monitoring the pressure and temperature of the hydraulic oil in the tank.

The second hydraulic assembly 108 is designed as a backup assembly and, in a fault condition of the steering system 100, is connected to the steering gear 102.

As an alternative or in addition, the second hydraulic assembly 108 can be connected to the steering gear 102 in an inactivity condition of the steering system 100.

Here, “connected” should generally be understood to mean that a continuous flow path between the working spaces 122, 124 of the steering gear is provided by the second hydraulic assembly 108.

Among the components of the second hydraulic assembly 108 are a hydraulic filter element 126 and a backup switching valve 128.

The hydraulic filter element 126 and the backup switching valve 128 form a series circuit.

The hydraulic filter element 126 is arranged upstream of the backup switching valve 128.

A pressure sensor 144 for monitoring the filter condition and a bypass check valve or filter check valve 146 can be arranged in parallel with the hydraulic filter element 126.

The pressure sensor 144 can be designed as a differential pressure sensor or, alternatively, as two individual pressure sensors or pressure switches with an adjustable trigger threshold (not shown in FIG. 1).

The pressure sensor 144 described above, the further above-described sensors of the first hydraulic assembly 106, and the electric motor M are connected to the electronic open-loop and/or closed-loop control device 114 by corresponding lines (not shown in FIG. 1).

The second hydraulic assembly 108 has a further first line 130 and a further second line 132.

The further first line 130 is connected to the first working space 122 of the steering gear housing 104.

In corresponding fashion, the further second line 132 is connected to the second working space 124 of the steering gear housing 104.

According to the illustration of the switching position of the backup switching valve 128 in FIG. 1, it is switched to a through flow position in accordance with the inactivity condition or fault condition.

Accordingly, the first working space 122 and the second working space 124 are connected via the further first and further second lines 130, 132 and via the hydraulic filter element 126 and the backup switching valve 128.

According to FIG. 1, the second hydraulic assembly 108 further comprises a bridge circuit 134, which has four outer arms 136 and a bridge arm 138, wherein the four outer arms 136 are connected to one another by four outer nodes 140.

The bridge arm 138 in turn is formed by the series circuit comprising the hydraulic filter element 126 and the backup switching valve 128.

Accordingly, the first working space 122 and the second working space 124 are connected to one another via the further first and further second lines 130, 132 and via the bridge circuit 234.

For this purpose, the bridge circuit 134 is connected by means of two outer nodes 140 to the further first line 130 and the further second line 132.

The bridge arm 138 in turn is connected to two further outer nodes 140 of the bridge circuit which are not connected to the further first and second lines 130, 132.

A hydraulic filter element can be arranged in each of the further first and second lines 118, 120.

The backup switching valve 128 is designed as a 2/2-way solenoid valve and has a switching tappet and a solenoid for actuating the switching tappet, wherein a change in the switching position of the switching tappet triggers an induced voltage in the solenoid.

Moreover, according to the invention, a utility vehicle is provided (not shown in FIG. 1) which comprises an electrohydraulic steering system 100 as described above.

The operation of the steering system 100 according to the invention may now be described as follows:

In principle, the steering gear 102 can be supplied with hydraulic fluid by the hydraulic pump 116.

In addition, by virtue of its bidirectional configuration, the steering gear 102 can be controlled by the hydraulic pump 116.

To be more precise, the first working space 122 can be supplied with hydraulic fluid by the first line 118, and thereby controlled, since the first line 118 connects this working space 122 to the hydraulic pump 116.

In corresponding fashion, the second working space 124 can be supplied with hydraulic fluid by the second line 120, and thereby controlled, since the second line 120 connects this working space 124 to the hydraulic pump 116.

Control is exercised by pressurization of either the first working space 122 or the second working space 124 of the steering gear—but not both simultaneously—by the hydraulic pump 116.

Accordingly, the hydraulic pump 116 is configured to pressurize the first line 118 in accordance with the first delivery direction and to pressurize the second line 120 in accordance with the second delivery direction.

As soon as the hydraulic pump 116 is driven by the electric motor M (e.g. clockwise), it pressurizes the first line 118, which extends as far as the first working space 122, in accordance with its first delivery direction.

Consequently, the hydraulic pump 116 and the steering gear 102 are connected to one another by the first line 118, and the port of the steering gear 102 which is connected to the first line 118 and opens into the first working space 122 is pressurized.

The pressure in the first working space 122 is then increased, and the piston is forced to make a linear displacement movement since there is a lower pressure prevailing in the opposite, second working space 124, and therefore steering assistance is achieved via the steering output shaft.

The pressure in the opposite, second working space 124 is therefore lower because this working space 124 is connected to the tank by the second line 120 and a corresponding return line (not shown in FIG. 1).

The hydraulic oil can thus flow back from the second working space 124 into the tank.

It is important to understand in this context that the hydraulic pump 116 is only ever driven in one direction of rotation and it is thus only ever possible for the first or the second line 118, 120 to be pressurized.

If the direction of rotation of the hydraulic pump 116 is reversed, the above-described relationship or case applies precisely in the opposite order to that described below:

As soon as the hydraulic pump 116 is driven by the electric motor M (e.g. counterclockwise), it pressurizes the second line 120, which extends as far as the second working space 124, in accordance with a second delivery direction.

Consequently, the hydraulic pump 116 and the steering gear 102 are connected to one another by the second line 120, and the port of the steering gear 102 which is connected to the second line 120 and opens into the second working space 124 is pressurized.

The pressure in the second working space 124 is then increased, and the piston is forced to make a linear displacement movement since there is now a lower pressure prevailing in the opposite, first working space 122, and therefore steering assistance is achieved via the steering output shaft.

The pressure in the opposite, first working space 122 is therefore lower because this working space 122 is connected to the tank by the first line 118 and a corresponding return line (not shown in FIG. 1).

As a consequence, the hydraulic oil can flow back from the first working space 122 into the tank.

It is important to understand in this context that the hydraulic pump 116 is only ever driven in one direction of rotation and it is thus only ever possible for the first or the second line 118, 120 to be pressurized.

The above operation of the steering system 100 has been described in accordance with a normal operating condition, while the following description of operation explains an inactivity condition or a fault condition of the system:

In this state, the backup switching valve 128 is arranged in the through flow switching position shown in FIG. 1.

This position allows an uninterrupted flow path from the first working space 122 to the second working space 124 via the further first and further second lines 130, 132 and via the bridge circuit 134.

The flow direction of the hydraulic oil depends on the pressure gradient between the first and second working spaces 122, 124.

The pressure gradient can arise either exclusively from a manual steering movement of the steering input shaft, which is illustrated on the left of the second working space 124 in FIG. 1, wherein the steering input shaft can also be arranged at some other location.

This is because the rotation of the steering shaft ensures the linear displacement movement of the steering gear piston via the internal spindle (in this case, there is no pressurization by the hydraulic pump 116), wherein this case is assigned to the fault condition.

As an alternative, the pressure gradient can be formed, as described above, by the selective pressurization of the first or second working space 122, 124 by the hydraulic pump 116, wherein this case is assigned to an inactivity condition of the steering system.

In this case, the steering system operates normally, and therefore the backup switching valve 128 has been driven by the open-loop and/or closed-loop control device and has thus been switched to the through flow position.

The inactivity condition is the condition when the steering system is inactive, i.e. when either the utility vehicle is currently not in motion or the utility vehicle is in motion and no steering assistance will be required in the future.

In other words, there is a certain probability that future steering assistance (and thus no pressurization of the steering gear 102) of the steering system is not to be expected.

In this condition, it is advantageously possible to make use of the further functional occupation of the second assembly 108 in the form of the filtering of the hydraulic oil.

This is because the hydraulic pump 116 must operate more or less continuously, such that the driver feels a certain sense of resistance to steering and because it is only if the hydraulic pump is already operating that steering power assistance can be generated with sufficient rapidity.

Accordingly, the operation of the pump in the inactivity condition can be exploited in such a way that the hydraulic pump 116 pressurizes one of the two working spaces 122, 124 in such a way that the pressurization must be below a pressure threshold, which therefore does not initiate any actual steering assistance (this being possible by virtue of the system inertias and friction).

Since the filter element is arranged in the backup assembly, the hydraulic oil can thus be filtered in a very energy-efficient way.

If the pressure prevailing in the first working space 122 is higher than in the second working space 124, the following flow path or hydraulic flow through the following components is formed on this basis in the second assembly 108:
first further line 130 (optional hydraulic filter in this line);
outer node 140 which connects the bridge circuit 134 and further first line 130;
outer arm 136 open in flow direction (unambiguously defined by check valve arrangement);
bridge arm 138 with hydraulic filter element 126 and backup switching valve 128;
further outer arm 136 open in the flow direction, which connects the bridge arm 138 to the outer node 140 connected to the further second line 132;
further second line 132; and
second working space 124.

If the pressure prevailing in the second working space 124 is higher than in the first working space 122, the following flow path or hydraulic flow through the following components is formed on this basis in the second assembly:
further second line 132 (optional hydraulic filter in this line);
outer node 140 which connects the bridge circuit 134 and further second line 132;
outer arm 136 open in flow direction (unambiguously defined by check valve arrangement);
bridge arm 138 with hydraulic filter element 126 and backup switching valve 128;
further outer arm 136 open in the flow direction, which connects the bridge arm 138 to the outer node 140 connected to the further first line 130;
further first line 130; and
first working space 122.

The two flow paths described above enable the hydraulic oil to be cleaned by means of the hydraulic filter element 126, which is the main filter element.

Thus, the hydraulic oil can be cleaned very efficiently in the inactivity condition of the steering system 100 since the pressures required for this purpose are much lower than those required for steering assistance, and no additional pumps or valves are required for this purpose.

These pressures for filtering must not lead to the steering gear piston being actuated in such a way that it would trigger an actual steering movement, and therefore the pressures must remain below a pressure threshold.

On account of friction and inertias in the steering system, however, cleaning below this above-described threshold is entirely possible, therefore very efficient cleaning by means of the hydraulic filter element 126 is possible if future inactivity of the steering system 100 is to be expected.

### LIST OF REFERENCE SIGNS

100 electrohydraulic steering system
102 steering gear, in particular spindle steering gear
104 steering gear housing
106 first hydraulic, in particular electrohydraulic, assembly
108 second hydraulic, in particular electrohydraulic, assembly
110 first housing block
112 second housing block
114 electronic open-loop and/or closed-loop control device
116 hydraulic pump
118 first line
120 second line
122 first working space
124 second working space
126 hydraulic filter element
128 backup switching valve
130 further first line
132 further second line
134 bridge circuit
136 outer arm
138 bridge arm
140 outer node
142 check valve
144 pressure sensor
146 filter check valve
M electric motor

1. An electrohydraulic steering system for a vehicle comprising:
at least one steering gear with at least one steering gear housing;
at least one first hydraulic assembly, which can be secured on the steering gear housing; and
at least one second hydraulic assembly, which can be secured on the steering gear housing;
wherein one or more components of the first hydraulic assembly is/are integrated at least partially into a first housing block, and
wherein one or more components of the second hydraulic assembly is/are integrated at least partially into a second housing block, or
wherein one or more components of the first hydraulic assembly and of the second hydraulic assembly is/are integrated at least partially into a common housing block.

2. The electrohydraulic steering system as claimed in claim 1, wherein the common housing block comprises the first housing block and the second housing block.

3. The electrohydraulic steering system as claimed in claim 1, wherein the first hydraulic assembly comprises at least one hydraulic pump and at least one electric motor for driving the hydraulic pump, by means of which the steering gear can be supplied and/or controlled with hydraulic fluid.

4. The electrohydraulic steering system as claimed in claim 1, wherein the first hydraulic assembly comprises at least one first line, which is connected to at least one first working space of the steering gear housing and by means of which the first working space can be supplied and/or controlled with hydraulic fluid, and
wherein the first hydraulic assembly comprises at least one second line, which is connected to at least one second working space of the steering gear housing and by means of which the second working space can be supplied and/or controlled with hydraulic fluid.

5. The electrohydraulic steering system as claimed in claim 3, wherein the hydraulic pump is designed as a bidirectional hydraulic pump with a first and second delivery direction and is connected to the first line and to the second line,
wherein the hydraulic pump is configured to pressurize the first line in accordance with the first delivery direction and to pressurize the second line in accordance with the second delivery direction.

6. The electrohydraulic steering system as claimed in claim 1, wherein the second hydraulic assembly is designed as a backup assembly and, in at least one fault condition and/or in at least one inactivity condition of the steering system, is connected to the steering gear.

7. The electrohydraulic steering system as claimed in claim 1, wherein the second hydraulic assembly comprises at least one hydraulic filter element and at least one backup switching valve.

8. The electrohydraulic steering system as claimed in claim 7, wherein the hydraulic filter element and the backup switching valve form a series circuit.

9. The electrohydraulic steering system as claimed in claim 4, wherein the second hydraulic assembly comprises at least one further first line and at least one further second line,
wherein the further first line is connected to the first working space of the steering gear housing and wherein the further second line is connected to the second working space of the steering gear housing.

10. The electrohydraulic steering system as claimed in claim 7, wherein the backup switching valve is switched to a through flow position in the inactivity condition and/or fault condition, such that the first working space and the second working space are connected at least by the further first and further second line and via the hydraulic filter element and the backup switching valve.

11. The electrohydraulic steering system as claimed in claim 7, wherein the backup switching valve is designed as a 2/2-way solenoid valve and has at least one switching tappet and at least one solenoid for actuating the switching tappet,
wherein a change in the switching position of the switching tappet triggers an induced voltage in the solenoid.

12. The electrohydraulic steering system as claimed in claim 1, wherein the second hydraulic assembly comprises at least one bridge circuit, which has four outer arms and a bridge arm,
wherein the four outer arms are connected to one another by four outer nodes.

13. The electrohydraulic steering system as claimed in claim 12, wherein the bridge arm is formed by the series circuit comprising the hydraulic filter element and the backup switching valve.

14. The electrohydraulic steering system as claimed in claim 12, wherein the bridge circuit is connected to the further first line and the further second line by means of two outer nodes, and
wherein the bridge arm is connected to two further outer nodes.

15. A vehicle comprising at least one electrohydraulic steering system as claimed in claim 1.
